(19) United States
(12) Patent Application Publication
(10) Pub. No.: US 2026/0079416 A1
(43) Pub. Date: Mar. 19, 2026

(54) TONER

(71) Applicant: CANON KABUSHIKI KAISHA, Tokyo (JP)

(72) Inventors: MASATAKE TANAKA, Kanagawa (JP); MASAYA KOMURO, Shizuoka (JP)

(21) Appl. No.: 19/320,085

(22) Filed: Sep. 5, 2025

(30) Foreign Application Priority Data
Sep. 17, 2024 (JP) 2024-159955

(51) Int. Cl. G03G 9/08; G03G 9/087; G03G 9/09; G03G 9/093

(52) U.S. Cl. CPC G03G 9/0825; G03G 9/08782; G03G 9/08786; G03G 9/09328; G03G 9/09364; G03G 9/0918

(57) ABSTRACT

A toner having a toner particle containing a binder resin, wherein the binder resin contains a vinyl resin having a monomer unit having a long-chain alkyl group, the toner particle contains a first ester compound having a specific structure and a hydrocarbon wax, and the toner particle further contains a second ester compound having a specific structure different from that of the first ester compound.

### BACKGROUND

### Field of the Technology

The present disclosure relates to a toner that is used in an image forming method such as an electrophotographic method, an electrostatic recording method, and a toner jet method.

### Description of the Related Art

In recent years, further reduction in power consumption has been required for an electrophotographic image forming apparatus such as a multifunction printer and a printer. In the electrophotographic method, an electrostatic latent image is first formed on an electrophotographic photosensitive member (image carrier) by a charging and exposure step. Next, the electrostatic latent image is developed with a developer containing a toner, and a visualized image (fixed image) is obtained through a transfer step and a fixing step. Among the steps, the fixing step is a step that requires a relatively large amount of energy, and particularly reduction in the amount of heat required for the fixing apparatus is considered from the viewpoint of reducing power consumption. In the case of toner, there is a growing need for a so-called low-temperature fixing toner that can be fixed with a smaller amount of heat.

For example, Japanese Patent Application Laid-open No. 2014-035506 has proposed a toner that exhibits excellent low-temperature fixability and heat-resistant storage property by containing a styrene acrylic resin having a structural unit derived from a long-chain alkyl group-containing monomer and a crystalline ester compound.

In a case where a styrene acrylic resin having a structural unit derived from a long-chain alkyl group-containing monomer and a crystalline ester compound are added to a toner as the toner described in the literature, low-temperature fixability is reliably improved. However, according to the studies by the present inventors, this effect increases with the amount of these additives, but if too much is added, the release wax is also compatible, the releasability is impaired, and fixing failure tends to occur.

Specifically, hot offset occurs and image omission occurs at a portion where the toner laid-on level of the secondary color or the like is large. Therefore, it is difficult to further improve the low-temperature fixability.

### SUMMARY

The present disclosure provides a toner that exhibits both low-temperature fixability and releasability in a high dimension.

The present disclosure relates to a toner comprising a toner particle comprising a binder resin, wherein the binder resin comprises a vinyl resin having a monomer unit represented by the following Formula (1), the toner particle comprises a first ester compound that is at least one ester compound selected from the group consisting of an ester compound represented by the following Formula (2), an ester compound represented by the following Formula (3), and an ester compound represented by the following Formula (4), as well as a hydrocarbon wax, and the toner particle further comprises a second ester compound that is at least one ester compound selected from the group consisting of an ester compound represented by the following Formula (5), an ester compound represented by the following Formula (6), and an ester compound represented by the following Formula (7):

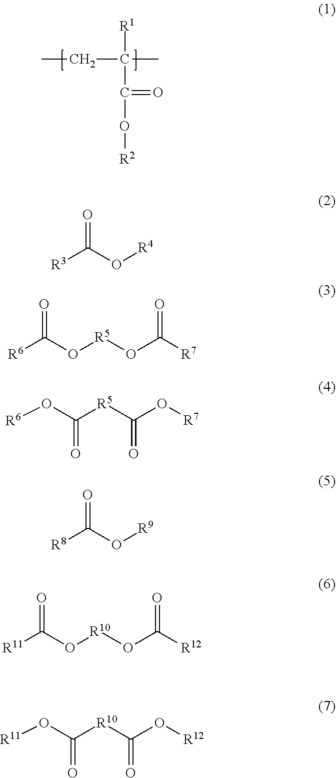

in Formula (1), R¹ represents a hydrogen atom or a methyl group, and R² represents a linear alkyl group having 8 to 22 carbon atoms, in Formula (2), R³ and R⁴ each independently represent a linear alkyl group having 16 to 22 carbon atoms (provided that a case where R⁴ has 19 to 22 carbon atoms is excluded when R³ has 19 to 22 carbon atoms), in Formula (3), R⁵ represents a linear alkylene group having 1 to 6 carbon atoms and R⁶ and R⁷ each independently represent a linear alkyl group having 14 to 22 carbon atoms, in Formula (4), R⁵ represents a linear alkylene group having 1 to 6 carbon atoms and R⁶ and R⁷ each independently represent a linear alkyl group having 14 to 22 carbon atoms, in Formula (5), R¹ represents a linear alkyl group having 21 carbon atoms and R⁹ represents a linear alkyl group having 22 carbon atoms, in Formula (6), R¹⁰ represents a linear alkylene group having 8 to 12 carbon atoms and R¹¹ and R¹² each independently represent a linear alkyl group having 18 to 22 carbon atoms, and in Formula (7), R¹⁰ represents a linear alkylene group having 8 to 12 carbon atoms and R¹¹ and R¹² each independently represent a linear alkyl group having 18 to 22 carbon atoms.

Features of the present disclosure will become apparent from the following description of embodiments. The following description of embodiments is described by way of example.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, a plurality of constituents may be selected from XX, and the same applies to YY and ZZ.

The term “monomer unit” refers to a reacted form of a monomer substance in a polymer. For example, one unit is one carbon-carbon bond segment in the main chain of a polymer formed by polymerizing vinyl monomers. The vinyl monomer can be represented by the following Formula (V).

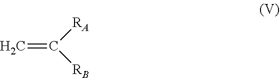

In Formula (V), R_{A} represents a hydrogen atom or an alkyl group (preferably an alkyl group having 1 to 3 carbon atoms, more preferably a methyl group), and RB represents an optional substituent.

The present inventors have studied to use a styrene acrylic resin having a structural unit derived from a long-chain alkyl group-containing monomer and an ester compound exhibiting high compatibility with this resin, and further increase the amount of the ester compound to improve low-temperature fixability, as described above. However, there are cases where the releasability significantly decreases, hot offset occurs, and image omission occurs at a portion where the toner laid-on level is large.

The reason for this is that the release agent is compatible with the binder resin by the structural unit derived from a long-chain alkyl group-containing monomer and the ester compound, and the release agent cannot outmigrate during fixation and the releasability is impaired. As a result of intensive studies on the method of suppressing the decrease in releasability while improving the low-temperature fixability, the present inventors have found out that the following configuration affords a desired effect. In other words, in a system using a vinyl resin having a structural unit derived from a long-chain alkyl group-containing monomer having a specific structure, a first ester compound exhibiting high compatibility with the specific structure of the vinyl resin, and a hydrocarbon wax as a release agent, a specific second ester compound is further added.

The present disclosure relates to a toner comprising a toner particle comprising a binder resin, wherein the binder resin comprises a vinyl resin having a monomer unit represented by the following Formula (1), the toner particle comprises a first ester compound that is at least one ester compound selected from the group consisting of an ester compound represented by the following Formula (2), an ester compound represented by the following Formula (3), and an ester compound represented by the following Formula (4), as well as a hydrocarbon wax, and the toner particle further comprises a second ester compound that is at least one ester compound selected from the group consisting of an ester compound represented by the following Formula (5), an ester compound represented by the following Formula (6), and an ester compound represented by the following Formula (7):

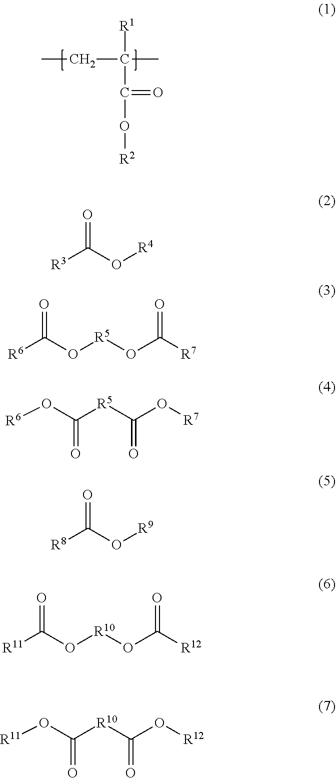

in Formula (1), R¹ represents a hydrogen atom or a methyl group, and R² represents a linear alkyl group having 8 to 22 carbon atoms, in Formula (2), R³ and R⁴ each independently represent a linear alkyl group having 16 to 22 carbon atoms (provided that a case where R⁴ has 19 to 22 carbon atoms is excluded when R³ has 19 to 22 carbon atoms), in Formula (3), R⁵ represents a linear alkylene group having 1 to 6 carbon atoms and R⁶ and R⁷ each independently represent a linear alkyl group having 14 to 22 carbon atoms, in Formula (4), R⁵ represents a linear alkylene group having 1 to 6 carbon atoms and R⁶ and R⁷ each independently represent a linear alkyl group having 14 to 22 carbon atoms, in Formula (5), R¹ represents a linear alkyl group having 21 carbon atoms and R⁹ represents a linear alkyl group having 22 carbon atoms, in Formula (6), R¹⁰ represents a linear alkylene group having 8 to 12 carbon atoms and R¹¹ and R¹² each independently represent a linear alkyl group having 18 to 22 carbon atoms, and in Formula (7), R¹⁰ represents a linear alkylene group having 8 to 12 carbon atoms and R¹¹ and R¹² each independently represent a linear alkyl group having 18 to 22 carbon atoms.

As the reason why both low-temperature fixability and releasability can be achieved in a high dimension by the above-described configuration, the present inventors have considered the following reasons. The second ester compound represented by Formulas (5) to (7) is an ester compound exhibiting low compatibility with a vinyl resin. It is considered that the second ester compound acts on the vinyl resin having a monomer unit represented by Formula (1) and the first ester compound that is represented by Formulas (2) to (4) and exhibits high compatibility with the vinyl resin during fixation. As a result, it is presumed that the hydrocarbon wax is prevented from being compatible with the binder resin.

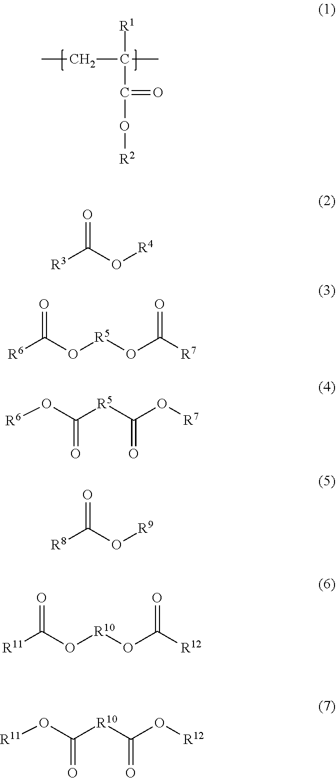

In Formula (1), R¹ represents a hydrogen atom or a methyl group, and R² represents a linear alkyl group having 8 to 22 (preferably 12 to 22) carbon atoms.

In Formula (2), R³ and R⁴ each independently represent a linear alkyl group having 16 to 22 carbon atoms (provided that a case where R⁴ has 19 to 22 carbon atoms is excluded when R³ has 19 to 22 carbon atoms).

In Formula (3), R⁵ represents a linear alkylene group having 1 to 6 (preferably 1 to 4 or 1 to 3) carbon atoms and R⁶ and R⁷ each independently represent a linear alkyl group having 14 to 22 (preferably 16 to 22) carbon atoms.

In Formula (4), R⁵ represents a linear alkylene group having 1 to 6 (preferably 1 to 4 or 1 to 3) carbon atoms and R⁶ and R⁷ each independently represent a linear alkyl group having 14 to 22 (preferably 16 to 22) carbon atoms.

In Formula (5), R⁸ represents a linear alkyl group having 21 carbon atoms and R⁹ represents a linear alkyl group having 22 carbon atoms.

In Formula (6), R¹⁰ represents a linear alkylene group having 8 to 12 carbon atoms and R¹¹ and R¹² each independently represent a linear alkyl group having 18 to 22 carbon atoms.

In Formula (7), R¹⁰ represents a linear alkylene group having 8 to 12 carbon atoms and R¹¹ and R¹² each independently represent a linear alkyl group having 18 to 22 carbon atoms.

The vinyl resin having a monomer unit represented by Formula (1) includes at least one resin selected from the group consisting of a styrene resin, an acrylic resin, a styrene acrylic resin, a polyethylene resin, a polyethylene vinyl acetate resin, a vinyl acetate resin, a polybutadiene resin, and the like. The vinyl resin having a monomer unit represented by Formula (1) is preferably a styrene acrylic resin having a monomer unit represented by Formula (1).

In Formula (1), R² is preferably a linear alkyl group having 12 to 22 carbon atoms from the viewpoint of achieving both low-temperature fixability and releasability. The monomer forming the monomer unit represented by Formula (1) (monomer for unit of Formula (1)) is, for example, a (meth)acrylic acid alkyl ester having a linear alkyl group having 8 to 22 (preferably 12 to 22) carbon atoms.

The vinyl resin has the monomer unit represented by Formula (1) at preferably 1.0% to 15.0% by mass, more preferably 4.0% to 10.0% by mass. When the content is in the above range, both low-temperature fixability and releasability are more easily achieved.

Examples of the vinyl resin include homopolymers composed of the following polymerizable monomers, copolymers obtained by combining two or more kinds of these, or mixtures thereof.

Styrene monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octyl styrene, p-n-nonylstyrene, p-n-decylstyrene, p-n-dodecylstyrene, p-methoxystyrene, and p-phenylstyrene; (meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid; vinyl ether monomers such as vinyl methyl ether and vinyl isobutyl ether; vinyl ketone monomers such as vinyl methyl ketone, vinyl ethyl ketone, and vinyl isopropenyl ketone; and polyolefins such as ethylene, propylene, and butadiene.

As the vinyl resin, a polyfunctional polymerizable monomer can be used if necessary. The polyfunctional polymerizable monomer, for example, includes diethyleneglycol di(meth)acrylate, triethyleneglycol di(meth)acrylate, tetraethyleneglycol di(meth)acrylate, polyethylene glycol di(meth)acrylate, 1,6-hexandiol di(meth)acrylate, neopentyl glycol di(meth)acrylate, tripropylene glycol di(meth)acrylate, polypropylene glycol di(meth)acrylate, 2,2′-bis(4-((meth)acryloxy diethoxy)phenyl)propane, trimethylolpropane tri(meth)acrylate, tetramethylolmethane tetra(meth)acrylate, divinylbenzene, divinylnaphthalene, divinyl ether, and the like.

The vinyl resin is preferably a polymer of a monomer mixture containing at least one selected from the group consisting of (meth)acrylic monomers and styrene. The styrene acrylic resin is more preferably a polymer of a monomer mixture containing styrene and n-butyl (meth)acrylate.

The content proportion of the monomer unit corresponding to styrene in the vinyl resin is preferably 50.0% to 95.0% by mass, 60.0% to 85.0% by mass.

The content proportion of the monomer unit corresponding to the (meth)acrylic monomer (preferably n-butyl (meth)acrylate) in the vinyl resin is preferably 5.0% to 40.0% by mass, 10.0% to 25.0% by mass.

The toner particle may contain a binder resin in addition to the vinyl resin having a monomer unit represented by Formula (1). The binder resin other than the vinyl resin having a monomer unit represented by Formula (1) is not particularly limited, and known ones as presented below can be used.

A styrene resin, an acrylic resin, a styrene acrylic resin, a polyethylene resin, a polyethylene vinyl acetate resin, a vinyl acetate resin, a polybutadiene resin, a phenol resin, a polyurethane resin, a polybutylal resin, a polyester resin and the like.

Among these, a styrene resin, an acrylic resin, a styrene acrylic resin, and the like are preferred from the viewpoint of toner characteristics.

The binder resin contains the vinyl resin having a monomer unit represented by Formula (1) at preferably 50% by mass or more, more preferably 70% by mass or more, still more preferably 80% by mass or more. The binder resin contains the vinyl resin having a monomer unit represented by Formula (1) at preferably 50% to 100% by mass, more preferably 70% to 95% by mass, still more preferably 80% to 95% by mass.

The content of the first ester compound, which is an ester compound represented by Formulas (2) to (4), is, for example, 8.0 to 20.0 parts by mass, preferably 8.0 to 15.0 parts by mass, more preferably 8.0 to 13.0 parts by mass with respect to 100 parts by mass of the binder resin. When the content is in the above range, both low-temperature fixability and releasability are more easily achieved.

The content of the second ester compound, which is an ester compound represented by Formulas (5) to (7), is, for example, 0.5 to 15.0 parts by mass, preferably 0.7 to 10.0 parts by mass, more preferably 0.8 to 9.0 parts by mass with respect to 100 parts by mass of the binder resin.

The hydrocarbon wax includes at least one selected from the group consisting of paraffin wax, microcrystalline wax, petroleum-based wax such as petrolatum, Fischer-Tropsch wax, and the like. The hydrocarbon wax preferably contains paraffin wax.

The content of the hydrocarbon wax is, for example, 1.0 to 15.0 parts by mass, preferably 1.3 to 10.0 parts by mass, more preferably 3.0 to 7.0 parts by mass with respect to 100 parts by mass of the binder resin. When the content is in the above range, both low-temperature fixability and releasability are more easily achieved.

It is preferable that the content of the second ester compound represented by Formulas (5) to (7) satisfies the following Formula (8) in a case where X is X≤0.23 and satisfies the following Formula (9) in a case where X is X>0.23 from the viewpoint of easily achieving both low-temperature fixability and releasability.

$$Y \geq - 50 X + 12.5 \qquad ( 8 )$$

$$Y \geq 1 \qquad ( 9 )$$

X: mass of the hydrocarbon wax in the toner particle/(mass of the binder resin in the toner particle+mass of the hydrocarbon wax in the toner particle)

Y: mass of the second ester compound in the toner particle/(mass of the binder resin in the toner particle+mass of the second ester compound in the toner particle)

By satisfying Formula (8) or (9), a sufficient amount of the second ester compound is present with respect to that of the hydrocarbon wax, and the compatibility of the hydrocarbon wax with the binder resin can be more sufficiently suppressed. Since the hydrocarbon wax tends to be easily compatible with the vinyl resin (X≤0.23) as X is smaller, the minimum amount of Y is larger to achieve a more sufficient effect. Formula (8) shows this relation.

X is, for example, 0.07 to 0.60, preferably 0.20 to 0.50.

Y is, for example, 1 to 9, preferably 1 to 6, more preferably 1 to 3.

The toner particle preferably contains at least one selected from the group consisting of aluminum and magnesium as a polyvalent metal element. The mass concentration of the polyvalent metal element in the toner particle is preferably 5 to 500 ppm, more preferably 5 to 300 ppm, still more preferably 7 to 100 ppm. When the content is in the above range, both low-temperature fixability and releasability are more easily achieved.

These polyvalent metal elements can be introduced into the toner particle by using a metal salt as a flocculant when the toner particle is produced by an emulsion aggregation method, or by adding the polyvalent metal element as an organometal compound into the oil layer when the toner particle is produced by a suspension polymerization method.

It is considered that the aluminum or magnesium element in the binder resin interacts with the ester group of the vinyl resin having a monomer unit of Formula (1), the first ester compound represented by Formulas (2) to (4), and the second ester compound represented by Formulas (5) to (7). It is presumed that the interaction improves affinity of these for each other and prevents compatibility of hydrocarbon wax to further improve releasability. Aluminum distearate is particularly preferred as the aluminum compound from the viewpoint of favorable dispersion in the binder resin. In other words, it is preferable that the toner particle contains aluminum distearate.

The binder resin may have an acid group-containing resin. It is preferable that the binder resin has an acid group-containing resin having an acid value of, for example, 2 to 30 mgKOH/g, preferably 3 to 25 mgKOH/g. The acid group-containing resin makes it easier to achieve both low-temperature fixability and releasability. It is presumed that the ester compound is compatible with the acid group-containing resin to increase the polarity of the compatible portion and prevents the compatibility of the hydrocarbon wax to further improve the releasability.

The acid group-containing resin is not particularly limited, and known resins such as those presented below can be used, but at least one selected from the group consisting of a styrene acrylic resin and a polyester resin is preferred.

The acid group-containing resin preferably contains a styrene acrylic resin. The styrene acrylic resin includes the polymer of a monomer mixture containing at least one selected from the group consisting of (meth)acrylic monomers and styrene described above. The acid value can be controlled by using monomers having acid groups such as (meth)acrylic acid and maleic acid in the monomer mixture.

The content of the acid group-containing resin in the binder resin is preferably 2% to 20% by mass, 4% to 15% by mass.

The value of the molar ratio (polyvalent metal element/ester) of the polyvalent metal element (at least one selected from the group consisting of aluminum and magnesium) to the ester groups contained in the first ester compound and second ester compound represented by Formulas (2) to (7) is, for example, 0.2000 or less, preferably 0.1000 or less. When the value is in the above range, the low-temperature fixability and the releasability are more easily achieved. It seems that the interaction of ester groups with each other via the polyvalent metal element easily occurs as the amount of polyvalent metal element is properly small. The value of the molar ratio (polyvalent metal element/ester) is preferably 0.0003 to 0.1000, more preferably 0.0010 to 0.0800, still more preferably 0.0011 to 0.0030.

The toner particle preferably has a surface layer containing an organosilicon polymer. By the surface layer containing an organosilicon polymer, toner characteristics (particularly durability) are easily improved in addition to both low-temperature fixability and releasability.

As the method for producing the organosilicon polymer, a sol-gel method is preferred. The sol-gel method is a method in which hydrolysis and condensation polymerization are performed using a liquid raw material as a starting material, and gelation is performed via a sol state. The method is used when glass, ceramics, organic-inorganic hybrid materials, and nanocomposites are synthesized. When this production method is used, functional materials of various shapes, such as surface layers, fibers, bulk bodies, and fine particles, can be produced from the liquid phase at low temperatures.

It is preferable that the organosilicon polymer present on the surface layer of the toner particle is specifically produced by hydrolysis and condensation polymerization of a silicon compound typified by an alkoxy silane.

By providing the surface layer containing this organosilicon polymer on the toner particle, a toner, which exhibits improved environmental stability, less undergoes a decrease in performance of the toner during long-term use, and is excellent in storage stability, can be obtained.

Furthermore, by the sol-gel method, a variety of microstructures and shapes can be made since the material is formed by starting from a liquid and gelling the liquid. In particular, in a case where the toner particle is produced in an aqueous medium, the organosilicon polymer is easily deposited on the surface of the toner particle due to the hydrophilicity of the organosilicon compound by a hydrophilic group such as a silanol group. The microstructures and shapes can be adjusted by the reaction temperature, reaction time, reaction solvent, pH, the kind and amount of organometal compound, and the like.

The organosilicon polymer on the surface layer of the toner particle is preferably at least one condensation polymer selected from the group consisting of the following organosilicon compounds.

Methyltrimethoxysilane, methyltriethoxysilane, methyltrichlorosilane, ethyltrimethoxysilane, ethyltriethoxysilane, ethyltrichlorosilane, ethyltriacetoxysilane, propyltrimethoxysilane, propyltriethoxysilane, propyltrichlorosilane, butyltrimethoxysilane, butyltriethoxysilane, butyltrichlorosilane, butylmethoxydichlorosilane, butylethoxydichlorosilane, hexyltrimethoxysilane, hexyltriethoxysilane, and the like.

The organosilicon compounds may be used singly or in combination of two or more kinds thereof.

The amount of the surface layer containing the organosilicon polymer is, for example, 1 to 10 parts by mass, 1.5 to 4 parts by mass with respect to 100 parts by mass of the binder resin.

The surface layer containing the organosilicon polymer does not necessarily cover the entire toner particle, and there may be a portion where other materials of the toner particle, such as the binder resin, are exposed.

The toner particle contains a colorant. The colorant is not particularly limited, and conventionally known colorants as those presented below can be used.

Examples of yellow colorants include iron oxide yellow, Naples yellow, Naphthol yellow S, Hansa yellow G, Hansa yellow 10G, benzidine yellow G, benzidine yellow GR, quinoline yellow lake, permanent yellow NCG, condensed azo compounds such as tartrazine lake, isoindolinone compounds, anthraquinone compounds, azo metal complexes, methine compounds, and allylamide compounds.

Specifically, C.I. pigment yellow 12, 13, 14, 15, 17, 62, 74, 83, 93, 94, 95, 109, 110, 111, 128, 129, 147, 155, 168, and 180 can be exemplified.

Examples of orange colorants include the following.

Permanent orange GTR, pyrazolone orange, vulcan orange, benzidine orange G, indanthrene brilliant orange RK, and indanthrene brilliant orange GK.

Examples of red colorants include red iron oxide, permanent red 4R, lithol red, pyrazolone red, watching red calcium salt, lake red C, lake red D, brilliant carmine 6B, brilliant carmine 3B, eoxine lake, Rhodamine lake B, condensed azo compounds such as alizarin lake, diketopyrrolopyrrole compounds, anthraquinone compounds, quinacridone compounds, basic dye lake compounds, naphthol compounds, benzimidazolone compounds, thioindigo compounds, and perylene compounds.

Specifically, C.I. pigment red 2, 3, 5, 6, 7, 23, 48: 2, 48: 3, 48: 4, 57: 1, 81: 1, 122, 144, 146, 166, 169, 177, 184, 185, 202, 206, 220, 221, and 254 can be exemplified.

Examples of blue colorants include alkali blue lake, Victoria blue lake, phthalocyanine blue, metal-free phthalocyanine blue, copper phthalocyanine compounds and their derivatives, such as phthalocyanine blue partial chloride, fast sky blue, and indanthrene blue BG; anthraquinone compounds, and basic dye lake compounds.

Specifically, C.I. pigment blue 1, 7, 15, 15: 1, 15: 2, 15: 3, 15: 4, 60, 62, and 66 can be exemplified.

Examples of purple colorants include fast violet B and methyl violet lake.

Examples of green colorants include pigment green B, malachite green lake, and final yellow green G.

Examples of white colorants include zinc white, titanium oxide, antimony white, and zinc sulfide.

Examples of black colorants include carbon black, aniline black, non-magnetic ferrite, magnetite, and those toned to black using the yellow, red and blue colorants. These colorants may be used singly or in mixture, and can also be used in the state of a solid solution.

The content of the colorant is preferably from 3.0 parts by mass to 10.0 parts by mass with respect to 100 parts by mass of the binder resin.

The toner particle may contain a charge control agent. As the charge control agent, known ones can be used. Examples of negative charge control agents include metal compounds of aromatic carboxylic acids typified by salicylic acid, alkylsalicylic acid, dialkylsalicylic acid, naphthoic acid and dicarboxylic acids; metal salts or metal complexes of azo dyes or azo pigments; boron compounds, silicon compounds, and calixarenes. Examples of positive charge control agents include quaternary ammonium salts, high molecular weight compounds having quaternary ammonium salts in the side chain; guanidine compounds; nigrosine compounds; and imidazole compounds.

The content of the charge control agent is preferably from 0.01 parts by mass to 10 parts by mass with respect to 100 parts by mass of the binder resin.

The toner particle may be used as it is as a toner. In order to improve flowability, charging performance, cleaning performance, and the like, a fluidizing agent, a cleaning aid, and the like, which are so-called external additives, may be added to the toner particle to obtain a toner.

Examples of the external additives include inorganic oxide fine particle such as silica fine particle, alumina fine particle, and titanium oxide fine particle, inorganic stearic acid compound fine particle such as aluminum stearate fine particle and zinc stearate fine particle, or inorganic titanate compound fine particle such as strontium titanate and zinc titanate. These may be used singly or in combination of two or more kinds thereof.

These inorganic fine particle is preferably subjected to gloss treatment using a silane coupling agent, a titanium coupling agent, a higher fatty acid, silicone oil or the like in order to improve heat-resistant storage property and environmental stability. The BET specific surface area of the external additive is preferably from 10 m²/g to 450 m²/g.

The BET specific surface area can be determined by a low temperature gas adsorption method by a dynamic constant pressure method, according to a BET method (preferably, a BET multipoint method). For example, the BET specific surface area (m²/g) can be calculated by adsorbing nitrogen gas onto the sample surface and performing measurement by the BET multipoint method using a specific surface area measuring apparatus (trade name: GEMINI 2375 Ver.5.0, manufactured by Shimadzu Corporation).

The total amount of these various external additives added is preferably from 0.05 parts by mass to 5 parts by mass, more preferably from 0.1 parts by mass to 3 parts by mass with respect to 100 parts by mass of the toner particle. As the external additives, various ones may be used in combination.

The toner can also be used as a magnetic or non-magnetic one-component developer, but may also be mixed with a carrier and used as a two-component developer. As the carrier, magnetic particle formed of known materials such as metals such as iron, ferrite, and magnetite, and alloys of these metals with metals such as aluminum and lead can be used, and among these, ferrite particle is preferably used.

As the carrier, a coated carrier in which the surface of magnetic particle is coated with a coating agent such as a resin, and a resin-dispersed carrier in which a magnetic fine powder is dispersed in a binder resin may be used. As the carrier, one having a volume average particle diameter of from 15 μm to 100 μm is preferred, and one having a volume average particle diameter of from 25 μm to 80 μm is more preferred.

The toner particle can be produced by known production methods such as a pulverization method, a suspension polymerization method, an emulsion aggregation method, and a dissolution suspension method, and the production method is not particularly limited. A suspension polymerization method is preferred. In other words, the toner particle is preferably a suspension-polymerized toner particle.

The weight-average particle diameter (D4) of the toner is, for example, 4.0 to 12.0 μm, preferably 4.0 to 10.0 μm.

Hereinafter, various measurement methods relating to the present disclosure will be described.

Method for Separating Ester Compound and Hydrocarbon Wax and Method for Identifying Structure and Content

### Separation Method

The toner is dissolved in tetrahydrofuran (THF) and the solvent is removed from the obtained soluble matter under reduced pressure to obtain the THF-soluble matter of the toner.

The obtained THF-soluble matter of the toner is dissolved in chloroform to prepare a sample solution at a concentration of 25 mg/mL.

Into the following apparatus, 3.5 mL of the obtained sample solution is injected, and those having a number average molecular weight (Mn) of less than 2000 are subjected to preparative isolation under the following conditions.

Preparative GPC apparatus: Preparative HPLC LC-980 manufactured by Japan Analytical Industry Co., Ltd.

Column for preparative isolation: JAIGEL 3H and JAIGEL 5H (manufactured by Japan Analytical Industry Co., Ltd.)

### Eluent: Chloroform

Flow velocity: 3.5 mL/min

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

The components having a number average molecular weight (Mn) of less than 2000 include the first ester compound, the second ester compound, and the hydrocarbon wax. The components having a number average molecular weight (Mn) of 2000 or more include the vinyl resin having a monomer unit represented by Formula (1) and the acid group-containing resin, and the like.

Furthermore, if necessary, the components are further subjected to fractionation and preparative isolation by silica gel column chromatography (developing solvent: chloroform, toluene, hexane, methanol, or the like), or the solid is subjected to preparative isolation by a recrystallization method (solvent: acetone, hexane or the like), then the solvent is removed by distillation, and the residue is dried under reduced pressure by heating. The operations are repeated until each component is obtained by about 100 mg.

### Identification of Structure and Content

The structures of the separated components are identified by nuclear magnetic resonance spectroscopy (¹H-NMR) [400 MHz, CDCl₃, room temperature (25° C.)].
Measuring apparatus: FT NMR apparatus JNM-EX400 (manufactured by JEOL Ltd.)
Measurement frequency: 400 MHz
Pulse condition: 5.0 μs
Frequency range: 10500 Hz
Cumulative number of measurements: 64

NMR measurement of the toner is performed by the method and the result is compared with that of each isolated component, and from the spectrum intensities, the contents of the first ester compound, the second ester compound, the hydrocarbon wax and the binder resin are determined. This makes it possible to determine the parts by mass of each material, such as the first ester compound, with respect to 100 parts by mass of the binder resin.

Through the analysis by ¹H-NMR, the content proportion of the monomer unit represented by Formula (1) in the vinyl resin and the amounts of ester groups in the first ester compound and second ester compound can be calculated.

Measurement of Content of Polyvalent Metal Element by Fluorescent X-ray Analysis

A wavelength dispersion type fluorescent X-ray analyzer “Axios” (manufactured by Panalytical Ltd.) and attached dedicated software “SuperQ ver. 4.0F” (developed by Panalytical Ltd.) for setting measurement conditions and analyzing measured data are used. Rh is used as the anode of the X-ray tube, the measurement atmosphere is set to a vacuum, the measurement diameter (collimator mask diameter) is set to 27 mm, and the measurement time is set to 10 seconds. In addition, detection is performed with a proportional counter (PC) in the case of measuring a light element and with a scintillation counter (SC) in the case of measuring a heavy element.

As a measurement sample, 4 g of toner particle is put into a dedicated aluminum ring for pressing, flattened, pressurized at 20 MPa for 60 seconds using a tablet molding compressor “BRE-32” (manufactured by Maekawa Testing Machine Mfg. Co., Ltd.), and molded to pellets having a thickness of about 2 mm and a diameter of 39 mm, and the pellets are used.

For quantitation, the polyvalent metal to be quantitated is added to 100 parts by mass of the resin sample that does not contain a metal element so as to be 5.0 ppm by mass, and mixing is performed sufficiently using a coffee mill. Similarly, each of the polyvalent metals to be quantitated is mixed with the resin sample so as to be 50.0 ppm, 500.0 ppm, and 5000.0 ppm, and these mixtures are used as samples for calibration curve.

For each sample, pellets of the sample for calibration curve are produced as described above using a tablet molding compressor, and subjected to measurement. At this time, the accelerating voltage and current value of the X-ray generator are set to 24 kV and 100 mA, respectively. A calibration curve of a linear function is acquired with the acquired count rate of X-ray indicated along the vertical axis and the amount of polyvalent metal added in each sample for calibration curve indicated along the horizontal axis.

Next, the toner particle to be analyzed is formed into pellets as described above using a tablet molding compressor, and subjected to measurement. Then, the content (mass concentration) of the polyvalent metal element in the toner particle is determined from the calibration curve.

### Calculation of Net Intensity

The X-ray intensity acquired by subtracting the background intensity from the X-ray intensity at a peak angle indicating the presence of a metal element acquired by the measurement is taken as net intensity.

### Separation of External Additive

In a case where the surface of the toner particle is treated with an external additive and the like, the external additive can be removed by the following method if necessary to obtain the toner particle.

160 g of sucrose (manufactured by Kishida Chemical Co., Ltd.) is added to 100 mL of ion exchanged water and dissolved in hot water tank to prepare a sucrose concentrated solution. 31 g of the sucrose concentrated solution and 6 mL of Contaminon N (a 10% by mass aqueous solution of a neutral detergent with pH 7 for washing precision measurement instruments, containing a nonionic surfactant, an anionic surfactant, and an organic builder, manufactured by Wako Pure Chemical Industries, Ltd.) are put into a centrifugation tube (capacity 50 mL) to prepare a dispersion. 1.0 g of the toner is added to this dispersion, and a lump of the toner is loosened with a spatula or the like.

The centrifugation tube is shaken in a shaker at 350 spm (strokes per min) for 20 minutes. After shaking, the solution is transferred to a swing rotor glass tube (capacity 50 mL), and subjected to separation using a centrifugal separator (H-9R, manufactured by Kokusan Co., Ltd.) under conditions of 3,500 rpm and 30 minutes. According to this operation, the toner particle and the removed external additive are separated from each other. It is visually confirmed that the toner and the aqueous solution are sufficiently separated from each other, and the toner particle separated in the top layer is collected with a spatula or the like. The collected toner particle is filtered through a vacuum filter and then dried in a dryer for 1 hour or longer to obtain the toner particle. This operation is performed a plurality of times to secure a required amount.

### Method for Confirming Surface Layer Containing Organosilicon Polymer

The presence or absence of a hydrocarbon group that binds to Si in the surface layer containing an organosilicon polymer was confirmed by ¹³C-NMR analysis.
¹³C-NMR (Solid) Measurement Conditions
Apparatus: JNM-ECX500II manufactured by JEOL RESONANCE
Sample: 150 mg of tetrahydrofuran-insoluble matter of toner particle for NMR measurement
Measurement temperature: Room temperature
Pulse mode: CP/MAS
Measurement nuclear frequency: 123.25 MHz (¹³C)
Reference material: Adamantane (external standard: 29.5 ppm)
Sample rotational speed: 20 kHz
Contact time: 2 ms
Delay time: 2 s
Cumulative number of measurements: 1024

In a case where the surface of the toner particle is treated with an external additive and the like, the toner particle from which the external additive is removed by the above-described method can be used.

### Measurement of Acid Value

The acid value of the acid group-containing resin separated by the above-described method can be measured according to the following procedure.

An acid value is the number of milligrams of potassium hydroxide required to neutralize an acid contained in 1 gram of a sample. The acid value of the resin is measured in conformity with JIS K 0070-1992, and specifically, the acid value of the resin is measured according to the following procedure.

### (1) Preparation of Reagent

1.0 g of phenolphthalein is dissolved in 90 ml of ethyl alcohol (95 vol %), and ion exchanged water is added to adjust the volume to 100 ml to obtain a phenolphthalein solution.

7 g of special grade potassium hydroxide is dissolved in 5 ml of water, and ethyl alcohol (95 vol %) is added to adjust the volume to 1 L. The resulting solution is put into an alkali-resistant container so as not to come into contact with carbon dioxide gas or the like, is allowed to stand for 3 days, and then is filtered to obtain a potassium hydroxide solution. The obtained potassium hydroxide solution is stored in an alkali-resistant container. The factor of the potassium hydroxide solution is determined from the amount of the potassium hydroxide solution required for neutralization when 25 ml of 0.1 mol/L hydrochloric acid is placed in an Erlenmeyer flask, several drops of the phenolphthalein solution are added, and titration with the potassium hydroxide solution is performed. The 0.1 mol/L hydrochloric acid is prepared in conformity with JIS K 8001-1998 and used.

### (2) Operation

### (A) Main Test

2.0 g of a sample of a pulverized resin is weighed exactly and added into a 200 ml Erlenmeyer flask, 100 ml of a mixed solution of toluene/ethanol (2:1) is added thereto, and the mixture is dissolved for 5 hours. Next, several drops of the phenolphthalein solution are added as an indicator, and titration is performed using the potassium hydroxide solution. Note that an end point of the titration is when a light red color of the indicator lasts for about 30 seconds.

### (B) Blank Test

The titration is performed by the same operation as above except that no sample is used (that is, only a mixed solution of toluene/ethanol (2:1) is used).

(3) The obtained result is substituted into the following formula to calculate the acid value.

$$A = [ ( C - B ) \times f \times 5.61 ] / S$$

Here, A is an acid value (mgKOH/g), B is the amount (ml) of the potassium hydroxide solution added in the blank test, C is the amount (ml) of the potassium hydroxide solution added in the main test, f is a factor of the potassium hydroxide solution, and S is a mass (g) of the sample.

### Method for Measuring Particle Diameter of Toner (Particle)

A precision particle size distribution measuring apparatus (trade name: Coulter Counter Multisizer 3) by pore electric resistance method and dedicated software (trade name: Beckman Coulter Multisizer 3 Version 3.51, developed by Beckman Coulter, Inc.) are used.

The aperture diameter is 100 m, the measurement is performed on 25,000 effective measurement channels, the measured data is analyzed, and the calculation is performed.

As an electrolyte aqueous solution used for the measurement, a solution prepared by dissolving special grade sodium chloride in ion exchanged water to a concentration of about 1% by mass, for example, “ISOTON II” (trade name) manufactured by Beckman Coulter, Inc. can be used. Before the measurement and the analysis, the dedicated software is set as described below.

In the “change standard measurement method (SOM) screen” of the dedicated software, the total count number in the control mode is set to 50,000 particles, the number of measurements is set to 1, and the Kd value is set to the value acquired using standard particle 10.0 μm (manufactured by Beckman Coulter, Inc.). The threshold and noise level are automatically set by pressing the threshold/noise level measurement button. The current is set to 1600 μA, the gain to 2, and the electrolyte to ISOTON II (trade name), and the aperture tube flush after measurement is checked.

In the “setting screen for converting pulse to particle diameter” in the dedicated software, the bin interval is set to the logarithmic particle diameter, the particle diameter bin to 256 particle diameter bin, and the particle diameter range to from 2 m to 60 m.

The specific measurement method is as follows.

(1) 200 mL of the electrolyte aqueous solution described above is put into a 250 mL round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.

(2) 30 mL of the electrolyte aqueous solution is put into a 100 mL flat-bottom glass beaker. 0.3 mL of a diluted solution prepared by diluting “Contaminon N” (trade name) (a 10% by mass aqueous solution of a neutral detergent for washing precision measurement instruments, manufactured by Wako Pure Chemical Industries, Ltd.) in 3 mass times of ion exchanged water is added thereto.

(3) Two oscillators with an oscillating frequency of 50 kHz are incorporated in a state where phases are shifted by 180 degrees, a predetermined amount of ion exchanged water and 2 mL of Contaminon N (trade name) are added into the water tank of an ultrasonic disperser having an electrical output of 120 W (trade name: Ultrasonic Dispersion System Tetoral50, manufactured by Nikkaki Bios Co., Ltd.).

(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.

(5) In a state where the electrolyte aqueous solution in the beaker in (4) has been irradiated with ultrasonic waves, 10 mg of the toner (particle) is added little by little to the electrolyte aqueous solution and dispersed. Further, the ultrasonic dispersion treatment is continued for 60 seconds. In the ultrasonic dispersion, the temperature of water in the water tank is appropriately adjusted so as to be from 10° C. to 40° C.

(6) Into the round-bottom beaker in (1) placed in the sample stand, the electrolyte aqueous solution in (5) in which the toner (particle) is dispersed is added dropwise using a pipette, and the measurement concentration is adjusted to 5%. In addition, the measurement is performed until the number of measurement particles reaches 50,000.

(7) The measured data is analyzed with the dedicated software attached to the apparatus to calculate the weight-average particle diameter (D4) or number average particle diameter (D1). The “average diameter” on the analysis/volume statistical value (arithmetic average) screen at the time of setting graph/% by volume with the dedicated software is the weight-average particle diameter (D4). The “average diameter” on the “analysis/number statistical value (arithmetic average)” screen at the time of setting graph/% by number with the dedicated software is the number average particle diameter (D1).

### EXAMPLES

Hereinafter, the present disclosure will be described in more detail with reference to specific production methods, Examples, and Comparative Examples, but these are not intended to limit the present disclosure in any way. The parts in the following blending are all by mass.

### Example 1

### Step of Preparing Aqueous Medium 1

To 500.0 parts of ion exchanged water in a reaction vessel, 7.0 parts of sodium phosphate (dodecahydrate, manufactured by RASA Industries, Ltd.) was added, and the mixture was kept warm at 65° C. for 1.0 hour while nitrogen purge was performed.

A calcium chloride aqueous solution containing 4.6 parts of calcium chloride (dihydrate) dissolved in 5.0 parts of ion exchanged water was collectively added while stirring was performed at 12000 rpm using a T.K. homomixer (manufactured by Tokushu Kika Kogyo Co., Ltd.), thereby preparing an aqueous medium containing a dispersion stabilizer. In addition, 10% by mass hydrochloric acid was added to the aqueous medium and the pH was adjusted to 5.0 to obtain an aqueous medium 1.

### Step of Hydrolyzing Organosilicon Compound for Surface Layer

60.0 parts of ion exchanged water was weighed and added into a reaction vessel equipped with a stirrer and a thermometer, and the pH was adjusted to 3.0 using 10% by mass hydrochloric acid. This was heated while being stirred so that the temperature reached 40° C.

Thereafter, 40.0 parts of methyltriethoxysilane as an organosilicon compound for surface layer was added, and the mixture was stirred for 3 hours or longer to perform hydrolysis. The end point of the hydrolysis was visually confirmed when oil and water were no longer separated and remained in a single layer, and cooling was performed to obtain a hydrolysis solution containing the organosilicon compound for surface layer.

### Step of Preparing Polymerizable Monomer Composition

Styrene: 60.0 parts
C.I. pigment blue 15: 3: 8.0 parts

The materials were added into an attritor (manufactured by Mitsui Miike Machinery Co., Ltd.), and further dispersed using zirconia particle having a diameter of 1.7 mm at 220 rpm for 5.0 hours to prepare a pigment-dispersed solution.

The following materials were added to the obtained pigment-dispersed solution.
Styrene: 17.0 parts
n-Butyl acrylate: 17.0 parts
Monomer for unit of Formula (1): 6.0 parts
Crosslinking agent (divinylbenzene): 0.50 parts
Polyvalent metal compound: 0.13 parts
(aluminum distearate)
First ester compound: 12.0 parts
Second ester compound: 1.0 part
Paraffin wax (hydrocarbon wax): 5.0 parts
(HNP51: NIPPON SEIRO CO., LTD., melting point 77° C.)
Acid group-containing resin: 12.0 parts
(Styrene-2-hydroxyethyl methacrylate-methacrylic acid-methyl methacrylate copolymer having acid value of 10 mgKOH/g, glass transition temperature (Tg) of 80° C., and weight-average molecular weight (Mw) of 15,000)

These were kept warm at 65° C. and uniformly dissolved and dispersed at 500 rpm using T.K. homomixer (manufactured by Tokushu Kika Kogyo Co., Ltd.) to prepare a polymerizable monomer composition.

### Granulating Step

While the temperature of the aqueous medium 1 was kept at 70° C. and the rotational speed of the T.K. homomixer at 12,000 rpm, the polymerizable monomer composition was added to the aqueous medium 1, and 6.0 parts of PERBUTYL PV (10-hour half-life temperature 54.6° C. (manufactured by NOF Corp.)) as a polymerization initiator was added. Granulation was directly performed for 10 minutes while the rotational speed was kept at 12,000 rpm using the stirring device.

### Polymerization Step

After the granulating step, the stirrer was replaced with a propeller stirring blade, polymerization was performed for 5.0 hours while stirring was performed at 150 rpm and the temperature was kept at 70° C., the temperature was raised to 85° C., and heating was performed for 2.0 hours to conduct the polymerization reaction, thereby obtaining core particles. The temperature of the slurry was lowered to 55° C. by cooling, and the pH was measured and found to be pH=5.0.

### Step of Forming Organosilicon Polymer Surface Layer

While stirring was continuously performed at 55° C., 15.0 parts of the hydrolysis solution of the organosilicon compound for surface layer was added to start formation of the surface layer of the toner particle. After the slurry was kept as it was for 30 minutes, the slurry was adjusted to pH=9.0 for complete condensation using an aqueous sodium hydroxide solution and kept for an additional 300 minutes, thereby forming the surface layer.

### Washing and Drying Step

After the polymerization step, a slurry of the toner particle was cooled, hydrochloric acid was added to the slurry of the toner particle to adjust the pH to 1.5 or less, stirring was performed for 1 hour, and then solid-liquid separation was performed using a pressure filter to obtain a toner cake. This was subjected to reslurry with ion exchanged water and formed into a dispersion again, and the dispersion was then subjected to solid-liquid separation using the pressure filter. After reslurry and solid-liquid separation were repeated until the electrical conductivity of the filtrate became 5.0 S/cm or less, solid-liquid separation was finally performed to obtain a toner cake.

The obtained toner cake was dried using an air flow drier, FLASH JET DRIER (manufactured by Seishin Corporation), and furthermore, fine coarse powder was cut using a multi-divided classifier utilizing the Coanda effect to obtain a toner particle 1. As drying conditions, the blowing temperature was 90° C., the drier outlet temperature was 40° C., and the feed rate of the toner cake was adjusted to a rate at which the outlet temperature did not deviate from 40° C. in accordance with the moisture content in the toner cake. The formulation of the toner particle 1 are presented in Table 1-1.

The obtained toner particle 1 was used as it was as a toner 1 without adding any external additives. The physical properties of the toner 1 are presented in Table 2-1.

The methods for evaluation performed on the toner 1 will be described below. Toner Evaluation

Laser Beam Printer LBP652C manufactured by Canon Inc. was modified so that the fixing temperature and process speed could be adjusted, and the following evaluation was performed.

The evaluation was performed in a normal temperature and humidity environment (temperature 23° C./humidity 60% RH). At a process speed of 320 mm/sec, the fixing temperature was changed in increments of 5° C. to form solid images (toner laid-on level: 0.40 mg/cm² and 0.95 mg/cm²). As the transfer material, plain paper (A4 size XEROX 4200 paper, manufactured by XEROX Corporation, 75 g/m²) was used.

The solid image (toner laid-on level: 0.40 mg/cm²) was used to visually evaluate the presence or absence of cold offset and hot offset. The solid image (toner laid-on level: 0.95 mg/cm²) was used to visually evaluate the presence or absence of image omission.

### Cold Offset Evaluation Criteria

A: No cold offset up to 140° C.
B: No cold offset up to 145° C.
C: No cold offset up to 150° C.
D: No cold offset up to 155° C.
E: Cold offset even at 160° C.

### Image Omission Evaluation Criteria

A: No image omission up to 150° C.
B: No image omission up to 155° C.
C: No image omission up to 160° C.
D: No image omission up to 165° C.
E: Image omission even at 170° C.

### Hot Offset Evaluation Criteria

A: No hot offset up to 200° C.
B: No hot offset up to 195° C.
C: No hot offset up to 190° C.
D: No hot offset up to 185° C.
E: Hot offset even at 180° C.

The evaluation results are presented in Table 3.

### Examples 2 to 16 and 18 to 21

Toners were produced in the same manner as in Example 1, except that the formulation was changed as presented in Tables 1-1 and 1-2. The physical properties and evaluation results of the obtained toners are presented in Tables 2-1 and 2-2.

### Example 17

A toner particle 17 was produced in the same manner as in Example 1, except that the formulation was changed as presented in Table 1-2. With respect to 100.0 parts of the obtained toner particle 17, 1.5 parts of silica particles RY200 (manufactured by NIPPON AEROSIL CO., LTD.) was externally added and mixed using FM10C (manufactured by Nippon Coke & Engineering Co., Ltd.). The external addition conditions were as follows: the lower blade was an A0 blade, the spacing from the wall of the deflector was set to 20 mm, and the external addition was performed at an amount of the toner particle charged: 2.0 kg, a rotational speed: 66.6 s⁻¹, an external addition time: 10 minutes, a temperature of cooling water of 20° C., and a flow rate of 10 L/min.

After that, the particle was sieved with a mesh having an opening size of 200 m, thereby obtaining the toner 17. The physical properties and evaluation results of the obtained toner 17 are presented in Table 2-2.

### Example 22

### (1) Preparation of Resin Fine Particle-Dispersed Solution for Core First-Stage Polymerization

A 5 L reaction vessel equipped with a stirring device, a temperature sensor, a cooling tube, and a nitrogen introduction device was charged with 4 parts of sodium polyoxyethylene (2) dodecyl ether sulfate and 3000 parts of ion exchanged water, the internal temperature was raised to 80° C. while stirring was performed at a stirring speed of 230 rpm in a nitrogen gas stream. After the temperature was raised, a solution prepared by dissolving 10 parts of potassium persulfate in 200 parts of ion exchanged water was added, and the liquid temperature was adjusted to 75° C.
568 parts of styrene
164 parts of n-butyl acrylate
68 parts of methacrylic acid

A monomer mixture composed of the above-mentioned monomers was added thereto dropwise over 1 hour, and then heating and stirring was performed at 75° C. for 2 hours to conduct polymerization, thereby preparing a resin particle-dispersed solution 1.

### Second-stage Polymerization

A 5 L reaction vessel equipped with a stirring device, a temperature sensor, a cooling tube, and a nitrogen introduction device was charged with a solution in which 2 parts of sodium polyoxyethylene (2) dodecyl ether sulfate was dissolved in 3000 parts of ion exchanged water, and the mixture was heated to 80° C. to obtain a solution A. Thereafter, a solution B was prepared in which 42 parts of the resin particle-dispersed solution 1 in terms of solid, 44 parts of HNP-51 (manufactured by NIPPON SEIRO CO., LTD.) as a hydrocarbon wax, 105 parts of the first ester compound, and 9 parts of the second ester compound were dissolved in a monomer solution composed of the following monomers at 80° C.
236 parts of styrene
52 parts of n-butyl acrylate
3 parts of n-octyl mercaptan

A dispersion containing emulsified particles (oil droplets) was then prepared by adding the solution B to the solution A and mixing and dispersing the mixture for 1 hour using a mechanical disperser “CLEARMIX” (manufactured by M Technique Co., Ltd.) having a circulation pathway.

Next, an initiator solution in which 5 parts of potassium persulfate was dissolved in 100 parts of ion exchanged water was added to this dispersion, and the system was heated and stirred at 80° C. over 1 hour to conduct the polymerization, thereby preparing a resin particle-dispersed solution 2.

### Third-stage Polymerization

To the resin particle-dispersed solution 2, a solution in which 10 parts of potassium persulfate was dissolved in 200 parts of ion exchanged water was further added. A monomer mixture composed of the following monomers was added thereto dropwise over 1 hour under a temperature condition of 80° C.
423 parts of styrene
93 parts of n-butyl acrylate
50 parts of n-stearyl acrylate
33 parts of methacrylic acid
6 parts of n-octyl mercaptan

After the dropwise addition, the polymerization was performed by performing heating and stirring for 2 hours, and then cooling was performed to 28° C., thereby obtaining a resin fine particle-dispersed solution for core 1.

### (2) Preparation of Resin Fine Particle-Dispersed Solution for Shell

A reaction vessel equipped with a stirring device, a temperature sensor, a cooling tube, and a nitrogen introduction device was charged with a surfactant solution in which 2.0 parts of sodium polyoxyethylene (2) dodecyl ether sulfate was dissolved in 3,000 parts of ion exchanged water, the internal temperature was raised to 80° C. while stirring was performed at a stirring speed of 230 rpm in a nitrogen gas stream.

An initiator solution in which 10 parts of potassium persulfate was dissolved in 200 parts of ion exchanged water was added to this solution, and a polymerizable monomer mixture prepared by mixing compounds composed of the following monomers was added dropwise over 3 hours.
568 parts of styrene
164 parts of n-butyl acrylate
68 parts of methacrylic acid
8 parts of n-octyl mercaptan

After the dropwise addition, this system was heated and stirred at 80° C. over 1 hour to conduct the polymerization, thereby obtaining a resin fine particle-dispersed solution for shell 1.

### (3) Preparation of Colorant Fine Particle-dispersed Solution

In 1600 parts of ion exchanged water, 90 parts of sodium dodecyl sulfate was stirred and dissolved. While this solution was stirred, 420 parts of C.I. pigment blue 15:3 was gradually added and then dispersed using a stirring device “CLEARMIX” (manufactured by M Technique Co., Ltd.), thereby preparing a colorant fine particle-dispersed solution 1.

### (4) Formation of Toner Particle

### Aggregation and Fusion Step

A 5 L reaction vessel equipped with a stirring device, a temperature sensor, a cooling tube, and a nitrogen introduction device was charged with 360 parts of resin fine particle-dispersed solution for core 1 in terms of solid, 1100 parts of ion exchanged water, and 35 parts of colorant fine particle-dispersed solution 1 in terms of solid, the liquid temperature was adjusted to 30° C., and then the pH was adjusted to 10 by adding a 5 N aqueous sodium hydroxide solution. Next, an aqueous solution of 60 parts of magnesium chloride dissolved in 60 parts of ion exchanged water was added thereto at 30° C. over 10 minutes under stirring. After the system was kept for 3 minutes, the temperature rise was started, the temperature of the system was raised to 85° C. over 60 minutes, and the particle growth reaction was continuously conducted while the temperature was kept at 85° C.

In this state, the particle diameter of the associated particles was measured using “Coulter Multisizer 3” (manufactured by Beckman Coulter Inc.), and when D4 reached 6.5 μm, an aqueous solution in which 40 parts of sodium chloride was dissolved in 160 parts of ion exchanged water was added to stop the particle growth, and further, as an aging step, heating and stirring was performed at a liquid temperature of 80° C. over 1 hour to progress the fusion between particles, thereby forming a core particle 1.

### Shelling Step

Next, 52 parts of the resin fine particle-dispersed solution for shell 1 in terms of solid was added, and stirring was continuously performed at 80° C. over 1 hour to fuse the resin fine particle for shell onto the surface of the core particle 1, thereby forming a shell layer. Here, an aqueous solution of 150 parts sodium chloride dissolved in 600 parts ion exchanged water was added, the aging treatment was performed at 80° C., and cooling to 30° C. was performed when the desired circularity was achieved.

### Washing and Drying Step

The cooled slurry was subjected to solid-liquid separation using a pressure filter to obtain a toner cake. This was subjected to reslurry with ion exchanged water and formed into a dispersion again, and the dispersion was then subjected to solid-liquid separation using the pressure filter. After reslurry and solid-liquid separation were repeated until the electrical conductivity of the filtrate became 5.0 S/cm or less, solid-liquid separation was finally performed to obtain a toner cake.

The obtained toner cake was dried using an air flow drier, FLASH JET DRIER (manufactured by Seishin Corporation), and furthermore, fine coarse powder was cut using a multi-divided classifier utilizing the Coanda effect to obtain a toner particle 22. As drying conditions, the blowing temperature was 90° C., the drier outlet temperature was 40° C., and the feed rate of the toner cake was adjusted to a rate at which the outlet temperature did not deviate from 40° C. in accordance with the moisture content in the toner cake. The formulation of the toner particle 22 are presented in Table 1-2.

### External Addition Step

With respect to 100.0 parts of the obtained toner particle 22, 1.5 parts of silica particles RY200 (manufactured by NIPPON AEROSIL CO., LTD.) was externally added and mixed using FM10C (manufactured by Nippon Coke & Engineering Co., Ltd.). The external addition conditions were as follows: the lower blade was an A0 blade, the spacing from the wall of the deflector was set to 20 mm, and the external addition was performed at an amount of the toner particle charged: 2.0 kg, a rotational speed: 66.6 s⁻¹, an external addition time: 10 minutes, a temperature of cooling water of 20° C., and a flow rate of 10 L/min.

After that, the particle was sieved with a mesh having an opening size of 200 m, thereby obtaining a toner 22. The physical properties and evaluation results of the obtained toner 22 are presented in Table 2-2.

### Comparative Example 1

### (1) Preparation of Resin Fine Particle-dispersed Solution for Core

### First-Stage Polymerization

A 5 L reaction vessel equipped with a stirring device, a temperature sensor, a cooling tube, and a nitrogen introduction device was charged with 4 parts of sodium polyoxyethylene (2) dodecyl ether sulfate and 3000 parts of ion exchanged water, the internal temperature was raised to 80° C. while stirring was performed at a stirring speed of 230 rpm in a nitrogen gas stream. After the temperature was raised, a solution prepared by dissolving 10 parts of potassium persulfate in 200 parts of ion exchanged water was added, and the liquid temperature was adjusted to 75° C.
568 parts of styrene
164 parts of n-butyl acrylate
68 parts of methacrylic acid

A monomer mixture composed of the above-mentioned monomers was added thereto dropwise over 1 hour, and then heating and stirring was performed at 75° C. for 2 hours to conduct polymerization, thereby preparing a resin particle-dispersed solution 1.

### Second-stage Polymerization

A 5 L reaction vessel equipped with a stirring device, a temperature sensor, a cooling tube, and a nitrogen introduction device was charged with a solution in which 2 parts of sodium polyoxyethylene (2) dodecyl ether sulfate was dissolved in 3000 parts of ion exchanged water, and the mixture was heated to 80° C. to obtain a solution A. Thereafter, a solution B was prepared in which 42 parts of the resin particle-dispersed solution 1 in terms of solid, 70 parts of HNP-0190 (manufactured by NIPPON SEIRO CO., LTD.) as a hydrocarbon wax, and 70 parts of ethylene glycol distearate were dissolved in a monomer solution composed of the following monomers at 80° C.
195 parts of styrene
91 parts of n-butyl acrylate
20 parts of methacrylic acid
3 parts of n-octyl mercaptan

A dispersion containing emulsified particles (oil droplets) was then prepared by adding the solution B to the solution A and mixing and dispersing the mixture for 1 hour using a mechanical disperser “CLEARMIX” (manufactured by M Technique Co., Ltd.) having a circulation pathway.

Next, an initiator solution in which 5 parts of potassium persulfate was dissolved in 100 parts of ion exchanged water was added to this dispersion, and the system was heated and stirred at 80° C. over 1 hour to conduct the polymerization, thereby preparing a resin particle-dispersed solution 2.

### Third-stage Polymerization

To the resin particle-dispersed solution 2, a solution in which 10 parts of potassium persulfate was dissolved in 200 parts of ion exchanged water was further added. A monomer mixture composed of the following monomers was added thereto dropwise over 1 hour under a temperature condition of 80° C.
298 parts of styrene
137 parts of n-butyl acrylate
50 parts of n-stearyl acrylate
64 parts of methacrylic acid
6 parts of n-octyl mercaptan

After the dropwise addition, the polymerization was performed by performing heating and stirring for 2 hours, and then cooling was performed to 28° C., thereby obtaining a resin fine particle-dispersed solution for core 1.

### (2) Preparation of Resin Fine Particle-Dispersed Solution for Shell

A reaction vessel equipped with a stirring device, a temperature sensor, a cooling tube, and a nitrogen introduction device was charged with a surfactant solution in which 2.0 parts of sodium polyoxyethylene (2) dodecyl ether sulfate was dissolved in 3,000 parts of ion exchanged water, the internal temperature was raised to 80° C. while stirring was performed at a stirring speed of 230 rpm in a nitrogen gas stream.

An initiator solution in which 10 parts of potassium persulfate was dissolved in 200 parts of ion exchanged water was added to this solution, and a polymerizable monomer mixture prepared by mixing compounds composed of the following monomers was added dropwise over 3 hours.
564 parts of styrene
140 parts of n-butyl acrylate
96 parts of methacrylic acid
12 parts of n-octyl mercaptan

After the dropwise addition, this system was heated and stirred at 80° C. over 1 hour to conduct the polymerization, thereby obtaining a resin fine particle-dispersed solution for shell 1.

### (3) Preparation of Colorant Fine Particle-Dispersed Solution

In 1600 parts of ion exchanged water, 90 parts of sodium dodecyl sulfate was stirred and dissolved. While this solution was stirred, 420 parts of C.I. pigment blue 15:3 was gradually added and then dispersed using a stirring device “CLEARMIX” (manufactured by M Technique Co., Ltd.), thereby preparing a colorant fine particle-dispersed solution 1.

### (4) Formation of Toner Particle

### Aggregation and Fusion Step

A 5 L reaction vessel equipped with a stirring device, a temperature sensor, a cooling tube, and a nitrogen introduction device was charged with 360 parts of resin fine particle-dispersed solution for core 1 in terms of solid, 1100 parts of ion exchanged water, and 200 parts of colorant fine particle-dispersed solution 1, the liquid temperature was adjusted to 30° C., and then the pH was adjusted to 10 by adding a 5 N aqueous sodium hydroxide solution. Next, an aqueous solution of 60 parts of magnesium chloride dissolved in 60 parts of ion exchanged water was added thereto at 30° C. over 10 minutes under stirring. After the system was kept for 3 minutes, the temperature rise was started, the temperature of the system was raised to 85° C. over 60 minutes, and the particle growth reaction was continuously conducted while the temperature was kept at 85° C.

In this state, the particle diameter of the associated particles was measured using “Coulter Multisizer 3” (manufactured by Beckman Coulter Inc.), and when D4 reached 6.5 μm, an aqueous solution in which 40 parts of sodium chloride was dissolved in 160 parts of ion exchanged water was added to stop the particle growth, and further, as an aging step, heating and stirring was performed at a liquid temperature of 80° C. over 1 hour to progress the fusion between particles, thereby forming a core particle 1.

### Shelling Step

Next, 40 parts of the resin fine particle-dispersed solution for shell 1 in terms of solid was added, and stirring was continuously performed at 80° C. over 1 hour to fuse the resin fine particle for shell onto the surface of the core particle 1, thereby forming a shell layer. Here, an aqueous solution of 150 parts sodium chloride dissolved in 600 parts ion exchanged water was added, the aging treatment was performed at 80° C., and cooling to 30° C. was performed when the desired circularity was achieved.

### Washing and Drying Step

The cooled slurry was subjected to solid-liquid separation using a pressure filter to obtain a toner cake. This was subjected to reslurry with ion exchanged water and formed into a dispersion again, and the dispersion was then subjected to solid-liquid separation using the pressure filter. After reslurry and solid-liquid separation were repeated until the electrical conductivity of the filtrate became 5.0 S/cm or less, solid-liquid separation was finally performed to obtain a toner cake.

The obtained toner cake was dried using an air flow drier, FLASH JET DRIER (manufactured by Seishin Corporation), and furthermore, fine coarse powder was cut using a multi-divided classifier utilizing the Coanda effect to obtain a comparative toner particle 1. As drying conditions, the blowing temperature was 90° C., the drier outlet temperature was 40° C., and the feed rate of the toner cake was adjusted to a rate at which the outlet temperature did not deviate from 40° C. in accordance with the moisture content in the toner cake. The formulation of the comparative toner particle 1 are presented in Table 1-2.

### External Addition Step

With respect to 100.0 parts of the obtained comparative toner particle 1, 1.5 parts of silica particles RY200 (manufactured by NIPPON AEROSIL CO., LTD.) was externally added and mixed using FM10C (manufactured by Nippon Coke & Engineering Co., Ltd.). The external addition conditions were as follows: the lower blade was an A0 blade, the spacing from the wall of the deflector was set to 20 mm, and the external addition was performed at an amount of the toner particle charged: 2.0 kg, a rotational speed: 66.6 s⁻¹, an external addition time: 10 minutes, a temperature of cooling water of 20° C., and a flow rate of 10 L/min.

After that, the particle was sieved with a mesh having an opening size of 200 m, thereby obtaining a comparative toner 1. The physical properties and evaluation results of the obtained comparative toner 1 are presented in Table 2-2.

### Comparative Example 2

A comparative toner 2 was produced in the same manner as the comparative toner 1 except that 70 parts of ethylene glycol distearate was changed to 70 parts of behenyl behenate in Comparative Example 1. The physical properties and evaluation results of the obtained comparative toner 2 are presented in Table 2-2.

TABLE 1-1

| Example No. | | 1 | 2 | 3 | 4 | 5 | 6 | 7 |
|---|---|---|---|---|---|---|---|---|
| Toner particle No. | | 1 | 2 | 3 | 4 | 5 | 6 | 7 |
| Monomer for unit | R1 | H | H | —CH3 | H | H | H | H |
| of Formula (1) | R2 | —C12H25 | —C8H17 | —C18H37 | —C22H45 | —C12H25 | —C12H25 | —C12H25 |
| | Content: % | 6.0 | 6.0 | 6.0 | 6.0 | 6.0 | 6.0 | 6.0 |
| | by mass | | | | | | | |
| First ester | Formula | (3) | (3) | (2) | (2) | (2) | (2) | (3) |
| compound | R3 | — | — | —C16H33 | —C18H37 | —C18H37 | —C22H45 | — |
| | R4 | — | — | —C16H33 | —C18H37 | —C22H45 | —C18H37 | — |
| | R5 | —C2H4— | —C2H4— | — | — | — | — | —C2H4— |
| | R6 | —C17H35 | —C17H35 | | — | — | — | —C17H35 |
| | R7 | —C17H35 | —C17H35 | | — | — | — | —C17H35 |
| | Parts | 12.0 | 12.0 | 12.0 | 12.0 | 12.0 | 12.0 | 12.0 |
| Hydrocarbon wax | Kind | HNP51 | HNP51 | HNP51 | HNP51 | HNP51 | HNP51 | HNP51 |
| | Parts | 5.0 | 5.0 | 5.0 | 5.0 | 5.0 | 5.0 | 5.0 |
| Second ester | Formula | (7) | (7) | (7) | (7) | (6) | (5) | (7) |
| compound | R8 | — | — | | — | — | —C21H43 | — |
| | R9 | — | — | — | — | — | —C22H45 | — |
| | R10 | —C8H16— | —C8H16— | —C8H16— | —C12H24— | —C10H20— | — | —C8H16— |
| | R11 | —C22H45 | —C22H45 | —C18H37 | —C22H45 | —C21H43 | — | —C22H45 |
| | R12 | —C22H45 | —C22H45 | —C18H37 | —C22H45 | —C21H43 | — | —C22H45 |
| | Parts | 1.0 | 1.0 | 1.0 | 1.0 | 1.0 | 1.0 | 1.0 |
| Acid group- | Acid value: | 10 | 10 | 10 | 10 | 10 | 10 | 10 |
| containing resin | mgKOH/g | | | | | | | |
| Polyvalent metal | Kind | Aluminum | Aluminum | Aluminum | Aluminum | Aluminum | Bontron | Magnesium |
| compound | | distearate | distearate | distearate | distearate | distearate | E88 | distearate |
| | Parts | 0.13 | 0.13 | 0.13 | 0.13 | 0.13 | 0.06 | 0.13 |

| | | | | | | | |
|---|---|---|---|---|---|---|---|
| Organosilicon polymer surface | Presence | Presence | Presence | Presence | Presence | Presence | Presence |
| layer forming step | | | | | | | |

| Example No. | | 8 | 9 | 10 | 11 | 12 |
|---|---|---|---|---|---|---|
| Toner particle No. | | 8 | 9 | 10 | 11 | 12 |
| Monomer for unit | R1 | H | H | H | H | H |
| of Formula (1) | R2 | —C12H25 | —C12H25 | —C12H25 | —C12H25 | —C12H25 |
| | Content: % | 1.0 | 15.0 | 6.0 | 6.0 | 6.0 |
| | by mass | | | | | |
| First ester | Formula | (3) | (3) | (3) | (4) | (3) |
| compound | R3 | — | — | — | — | — |
| | R4 | — | — | — | — | — |
| | R5 | —CH2— | —CH2— | —C6H12— | —C2H4— | —C2H4— |
| | R6 | —C14H29 | —C22H45 | —C22H45 | —C18H37 | —C17H35 |
| | R7 | —C14H29 | —C22H45 | —C22H45 | —C18H37 | —C17H35 |
| | Parts | 12.0 | 12.0 | 12.0 | 20.0 | 15.0 |
| Hydrocarbon wax | Kind | HNP51 | HNP51 | HNP51 | HNP51 | HNP51 |
| | Parts | 5.0 | 5.0 | 1.5 | 15.0 | 10.0 |
| Second ester | Formula | (7) | (7) | (7) | (7) | (7) |
| compound | R8 | — | — | — | — | — |
| | R9 | — | — | — | — | — |
| | R10 | —C8H16— | —C8H16— | —C8H16— | —C8H16— | —C8H16— |
| | R11 | —C22H45 | —C22H45 | —C22H45 | —C22H45 | —C22H45 |
| | R12 | —C22H45 | —C22H45 | —C22H45 | —C22H45 | —C22H45 |
| | Parts | 1.0 | 5.0 | 9.0 | 1.0 | 1.0 |
| Acid group- | Acid value: | 10 | 10 | 10 | 10 | 10 |
| containing resin | mgKOH/g | | | | | |
| Polyvalent metal | Kind | Aluminum | Aluminum | Aluminum | Aluminum | Aluminum |
| compound | | distearate | distearate | distearate | distearate | distearate |
| | Parts | 0.13 | 0.13 | 0.13 | 0.13 | 0.06 |

| | | | | | |
|---|---|---|---|---|---|
| Organosilicon polymer surface | Presence | Presence | Presence | Presence | Presence |
| layer forming step | | | | | |

TABLE 1-2

| Example No. | | 13 | 14 | 15 | 16 | 17 | 18 | 19 |
|---|---|---|---|---|---|---|---|---|
| Toner particle No. | | 13 | 14 | 15 | 16 | 17 | 18 | 19 |
| Monomer for unit of | R1 | H | H | H | H | H | H | H |
| Formula (1) | R2 | —C12H25 | —C12H25 | —C12H25 | —C12H25 | —C12H25 | —C12H25 | —C12H25 |
| | Content: | 6.0 | 6.0 | 6.0 | 6.0 | 6.0 | 6.0 | 6.0 |
| | % by mass | | | | | | | |
| First ester | Formula | (3) | (3) | (3) | (3) | (3) | (3) | (3) |
| compound | R3 | — | — | — | — | — | — | — |
| | R4 | — | — | — | — | — | — | — |
| | R5 | —C2H4— | —C2H4— | —C2H4— | —C2H4— | —C2H4— | —C6H12— | —C2H4— |
| | R6 | —C17H35 | —C17H35 | —C17H35 | —C17H35 | —C17H35 | —C22H45 | —C17H35 |
| | R7 | —C17H35 | —C17H35 | —C17H35 | —C17H35 | —C17H35 | —C22H45 | —C17H35 |
| | Parts | 10.0 | 10.0 | 12.0 | 12.0 | 12.0 | 12.0 | 12.0 |
| Hydrocarbon wax | Kind | HNP51 | HNP51 | HNP51 | HNP51 | HNP51 | HNP51 | HNP51 |
| | Parts | 5.0 | 5.0 | 5.0 | 5.0 | 3.0 | 1.5 | 5.0 |
| Second ester | Formula | (7) | (7) | (7) | (7) | (7) | (7) | (7) |
| compound | R8 | — | — | — | — | — | — | — |
| | R9 | — | — | — | — | — | — | — |
| | R10 | —C8H16— | —C8H16— | —C8H16— | —C8H16— | —C8H16— | —C8H16— | —C8H16— |
| | R11 | —C22H45 | —C22H45 | —C22H45 | —C22H45 | —C22H45 | —C22H45 | —C22H45 |
| | R12 | —C22H45 | —C22H45 | —C22H45 | —C22H45 | —C22H45 | —C22H45 | —C22H45 |
| | Parts | 1.0 | 1.0 | 1.0 | 1.0 | 4.0 | 5.0 | 1.0 |
| Acid group- | Acid value: | 10 | 10 | 3 | 25 | — | 10 | 10 |
| containing resin | mgKOH/g | | | | | | | |
| Polyvalent metal | Kind | Aluminum | Bontron | Aluminum | Aluminum | — | Aluminum | — |
| compound | | distearate | E88 | distearate | distearate | | distearate | |
| | Parts | 6.25 | 1.88 | 0.13 | 0.13 | — | 0.13 | — |

| | | | | | | | |
|---|---|---|---|---|---|---|---|
| Organosilicon polymer surface | Presence | Presence | Presence | Presence | Absence | Presence | Presence |
| layer forming step | | | | | | | |

| Example No. | | 20 | 21 | 22 | Comparative 1 | Comparative 2 |
|---|---|---|---|---|---|---|
| Toner particle No. | | 20 | 21 | 22 | Comparative 1 | Comparative 2 |
| Monomer for unit of | R1 | H | H | H | H | H |
| Formula (1) | R2 | —C12H25 | —C12H25 | —C12H25 | —C18H37 | —C18H37 |
| | Content: | 6.0 | 6.0 | 6.0 | 4.0 | 4.0 |
| | % by mass | | | | | |
| First ester compound | Formula | (3) | (3) | (3) | (3) | — |
| | R3 | — | — | — | — | — |
| | R4 | — | — | — | — | — |
| | R5 | —C2H4— | —C2H4— | —C2H4— | —C2H4— | — |
| | R6 | —C17H35 | —C17H35 | —C17H35 | —C17H35 | — |
| | R7 | —C17H35 | —C17H35 | —C17H35 | —C17H35 | — |
| | Parts | 10.0 | 12.0 | 12.0 | 6.0 | — |
| Hydrocarbon wax | Kind | HNP51 | HNP0190 | HNP51 | HNP0190 | HNP0190 |
| | Parts | 5.0 | 5.0 | 5.0 | 6.0 | 6.0 |
| Second ester compound | Formula | (7) | (7) | (7) | — | (5) |
| | R8 | — | — | — | — | —C21H43 |
| | R9 | — | — | — | — | —C22H45 |
| | R10 | —C8H16— | —C8H16— | —C8H16— | — | — |
| | R11 | —C22H45 | —C22H45 | —C22H45 | — | — |
| | R12 | —C22H45 | —C22H45 | —C22H45 | — | — |
| | Parts | 1.0 | 1.0 | 1.0 | — | 6.0 |
| Acid group-containing | Acid value: | 10 | 10 | 10 | — | — |
| resin | mgKOH/g | | | | | |
| Polyvalent metal | Kind | Bontron | Aluminum | Aluminum | — | — |
| compound | | E88 | distearate | distearate | | |
| | Parts | 4.38 | 0.13 | 0.13 | — | — |

| | | | | | |
|---|---|---|---|---|---|
| Organosilicon polymer surface | Presence | Presence | Absence | Absence | Absence |
| layer forming step | | | | | |

In Tables 1-1 and 1-2, the parts are parts by mass in the formulation of each toner. In the toner 22, the comparative toner 1 and the comparative toner 2, the parts represent parts by mass with respect to 100 parts by mass of the vinyl resin.

The content of the monomer for unit of Formula (1) is the content proportion (% by mass) of the monomer unit represented by Formula (1) in the vinyl resin.

TABLE 2-1

| Example No. | 1 | 2 | 3 | 4 | 5 | 6 | 7 | 8 | 9 | 10 | 11 | 12 |
|---|---|---|---|---|---|---|---|---|---|---|---|---|
| Toner No. | 1 | 2 | 3 | 4 | 5 | 6 | 7 | 8 | 9 | 10 | 11 | 12 |
| Particle diameter D4: μm | 7.0 | 7.0 | 7.0 | 7.0 | 7.0 | 7.0 | 7.0 | 7.0 | 7.0 | 7.0 | 7.0 | 7.0 |
| First ester compound | 10 | 10 | 10 | 10 | 10 | 10 | 10 | 11 | 9.4 | 10 | 17 | 13 |
| (parts with respect to 100 | | | | | | | | | | | | |
| parts of binder resin) | | | | | | | | | | | | |
| Hydrocarbon wax (parts | 4.2 | 4.2 | 4.2 | 4.2 | 4.2 | 4.2 | 4.2 | 4.4 | 3.9 | 1.3 | 13 | 8.4 |
| with respect to 100 parts | | | | | | | | | | | | |
| of binder resin) | | | | | | | | | | | | |
| X | 0.28 | 0.28 | 0.28 | 0.28 | 0.28 | 0.28 | 0.28 | 0.38 | 0.19 | 0.08 | 0.58 | 0.48 |
| Y | 1 | 1 | 1 | 1 | 1 | 1 | 1 | 1 | 5 | 9 | 1 | 1 |
| Kind of polyvalent metal | Al | Al | Al | Al | Al | Al | Mg | Al | Al | Al | Al | Al |
| element | | | | | | | | | | | | |
| Concentration of | 10 | 10 | 10 | 10 | 10 | 10 | 10 | 10 | 10 | 10 | 10 | 5 |
| polyvalent metal element: | | | | | | | | | | | | |
| ppm | | | | | | | | | | | | |
| Metal/ester molar ratio | 0.0013 | 0.0013 | 0.0020 | 0.0022 | 0.0024 | 0.0025 | 0.0014 | 0.0010 | 0.0013 | 0.0011 | 0.0009 | 0.0005 |
| Cold offset evaluation | A | A | A | A | A | A | A | B | A | A | B | A |
| Image omission | A | A | A | A | A | A | A | A | B | A | A | B |
| evaluation | | | | | | | | | | | | |
| Hot offset evaluation | A | A | A | A | A | A | A | A | B | A | A | B |

TABLE 2-2

| Example No. | 13 | 14 | 15 | 16 | 17 | 18 | 19 | 20 | 21 | 22 | Comparative 1 | Comparative 2 |
|---|---|---|---|---|---|---|---|---|---|---|---|---|
| Toner No. | 13 | 14 | 15 | 16 | 17 | 18 | 19 | 20 | 21 | 22 | Comparative 1 | Comparative 2 |
| Particle diameter D4: μm | 7.0 | 7.0 | 7.0 | 7.0 | 7.0 | 7.0 | 7.0 | 7.0 | 7.0 | 7.0 | 7.0 | 7.0 |
| First ester compound | 8.4 | 8.4 | 10 | 10 | 10 | 10 | 10 | 8.4 | 10 | 10 | 6.0 | — |
| (parts with respect to | | | | | | | | | | | | |
| 100 parts of binder | | | | | | | | | | | | |
| resin) | | | | | | | | | | | | |
| Hydrocarbon wax | 4.2 | 4.2 | 4.2 | 4.2 | 2.5 | 1.3 | 4.2 | 4.2 | 4.2 | 4.2 | 6.0 | 6.0 |
| (parts with respect to | | | | | | | | | | | | |
| 100 parts of binder | | | | | | | | | | | | |
| resin) | | | | | | | | | | | | |
| X | 0.31 | 0.28 | 0.28 | 0.28 | 0.17 | 0.08 | 0.28 | 0.31 | 0.28 | 0.28 | — | — |
| Y | 1 | 1 | 1 | 1 | 4 | 5 | 1 | 1 | 1 | 1 | — | 6 |
| Kind of polyvalent | Al | Al | Al | Al | — | Al | — | Al | Al | Al | — | — |
| metal element | | | | | | | | | | | | |
| Concentration of | 500 | 300 | 10 | 10 | — | 10 | — | 700 | 10 | 10 | — | — |
| polyvalent metal | | | | | | | | | | | | |
| element: ppm | | | | | | | | | | | | |
| Metal/ester molar ratio | 0.13 | 0.079 | 0.0013 | 0.0013 | — | 0.0013 | — | 0.19 | 0.0013 | 0.0013 | — | — |
| Cold offset evaluation | A | A | A | A | C | A | A | B | A | A | D | E |
| Image omission | C | B | A | A | C | C | C | B | A | A | E | E |
| evaluation | | | | | | | | | | | | |
| Hot offset evaluation | B | A | A | A | C | C | B | B | A | A | D | D |

In the tables, the metal/ester molar ratio indicates the value of the molar ratio of the polyvalent metal element to the ester groups contained in the first ester compound and second ester compound in the toner particle.

According to the present disclosure, it is possible to provide a toner that exhibits both low-temperature fixability and releasability in a high dimension.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159955, filed Sep. 17, 2024, which is hereby incorporated by reference herein in its entirety.

What is claimed is:

1. A toner comprising a toner particle comprising a binder resin, wherein
the binder resin comprises a vinyl resin having a monomer unit represented by the following Formula (1),
the toner particle comprises a first ester compound that is at least one ester compound selected from the group consisting of an ester compound represented by the following Formula (2), an ester compound represented by the following Formula (3), and an ester compound represented by the following Formula (4), as well as a hydrocarbon wax, and
the toner particle further comprises a second ester compound that is at least one ester compound selected from the group consisting of an ester compound represented by the following Formula (5), an ester compound represented by the following Formula (6), and an ester compound represented by the following Formula (7): 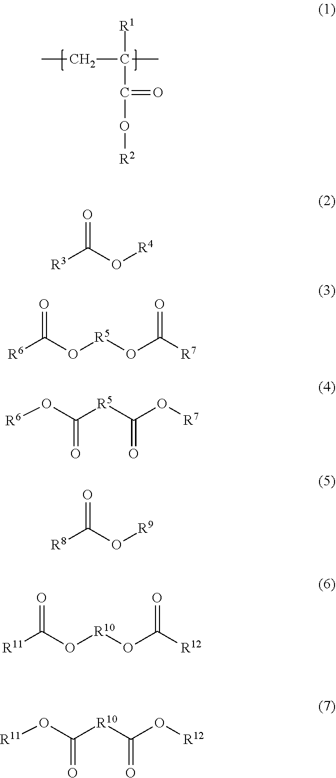
in Formula (1), R¹ represents a hydrogen atom or a methyl group, and R² represents a linear alkyl group having 8 to 22 carbon atoms,
in Formula (2), R³ and R⁴ each independently represent a linear alkyl group having 16 to 22 carbon atoms (provided that a case where R⁴ has 19 to 22 carbon atoms is excluded when R³ has 19 to 22 carbon atoms),
in Formula (3), R⁵ represents a linear alkylene group having 1 to 6 carbon atoms and R⁶ and R⁷ each independently represent a linear alkyl group having 14 to 22 carbon atoms,
in Formula (4), R⁵ represents a linear alkylene group having 1 to 6 carbon atoms and R⁶ and R⁷ each independently represent a linear alkyl group having 14 to 22 carbon atoms,
in Formula (5), R⁸ represents a linear alkyl group having 21 carbon atoms and R⁹ represents a linear alkyl group having 22 carbon atoms,
in Formula (6), R¹⁰ represents a linear alkylene group having 8 to 12 carbon atoms and R¹¹ and R¹² each independently represent a linear alkyl group having 18 to 22 carbon atoms, and
in Formula (7), R¹⁰ represents a linear alkylene group having 8 to 12 carbon atoms and R¹¹ and R¹² each independently represent a linear alkyl group having 18 to 22 carbon atoms.

2. The toner according to claim 1, wherein the vinyl resin has the monomer unit represented by Formula (1) at 1.0% to 15.0% by mass.

3. The toner according to claim 1, wherein a content of the hydrocarbon wax is 1.3 to 10.0 parts by mass with respect to 100 parts by mass of the binder resin.

4. The toner according to claim 1, wherein the following Formula (8) is satisfied when X is X≤0.23 and the following Formula (9) is satisfied when X is X>0.23:
$$Y \geq - 50 X + 12.5 \qquad ( 8 )$$
$$Y \geq 1 \qquad ( 9 )$$
X: mass of the hydrocarbon wax in the toner particle/(mass of the binder resin in the toner particle+mass of the hydrocarbon wax in the toner particle) and
Y: mass of the second ester compound in the toner particle/(mass of the binder resin in the toner particle+mass of the second ester compound in the toner particle).

5. The toner according to claim 1, wherein the toner particle comprises at least one selected from the group consisting of aluminum and magnesium as a polyvalent metal element, and
a mass concentration of the polyvalent metal element in the toner particle is 5 to 500 ppm.

6. The toner according to claim 5, wherein a value of a molar ratio of the polyvalent metal element to ester groups comprised in the first ester compound and the second ester compound in the toner particle is 0.1000 or less.

7. The toner according to claim 1, wherein the toner particle comprises aluminum distearate.

8. The toner according to claim 1, wherein the binder resin comprises an acid group-containing resin having an acid value of 3 to 25 mgKOH/g.

9. The toner according to claim 1, wherein the toner particle has a surface layer comprising an organosilicon polymer.
